(19) United States
(12) Patent Application Publication
(10) Pub. No.: US 2003/0074340 A1
(43) Pub. Date: Apr. 17, 2003

(54) System for checking treatment plans

(76) Inventors: Klaus Abraham-Fuchs, Erlangen (DE); Eva Rumpel, Erlangen (DE)

Correspondence Address: YOUNG & THOMPSON, 745 SOUTH 23RD STREET 2ND FLOOR, ARLINGTON, VA, 22202

(21) Appl. No.: 10/254,976

(22) Filed: Sep. 26, 2002

(30) Foreign Application Priority Data
Sep. 26, 2001 (DE) 101 47 471.7

(51) Int. Cl. G06N 5/02; G06F 17/00

(52) U.S. Cl. 706/46

(57) ABSTRACT

A system for checking treatment plans, especially in the course of disease management services for patient information, instruction and motivation, possibly combined with telemonitoring of critical body values and, on this basis, early detection of risk situations, having an expert system with expert rules stored in a computer databank which, by accessing patient data in different patient records and/or with different doctors or clinics, independently subjects the treatment plan to a plausibility check, especially checks the treatment plan for contraindications with older patient data.

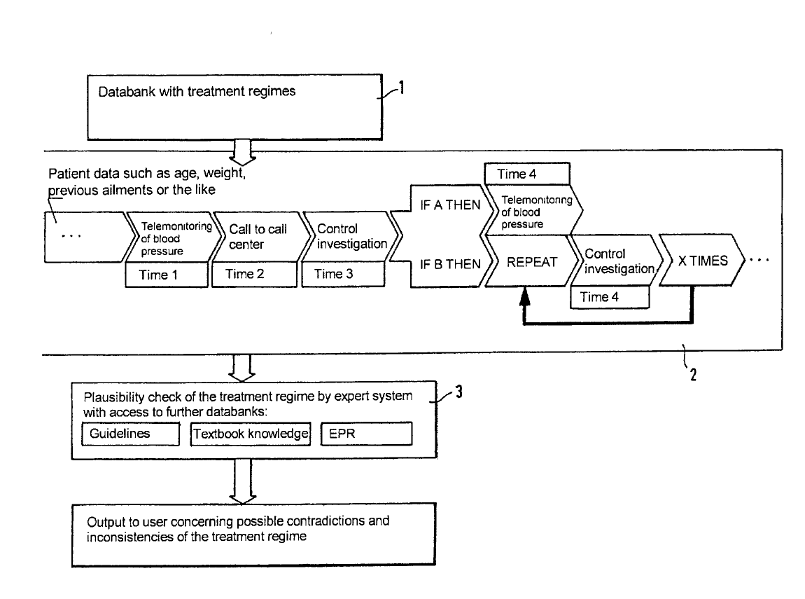

### FIELD OF THE INVENTION

The invention relates to a system for checking treatment plans, especially in the course of disease management services for patient information, instruction and motivation, possibly combined with telemonitoring of critical body values and, on this basis, early detection of risk situations.

### BACKGROUND OF THE INVENTION

Disease management services typically care for patients suffering from a chronic common ailment, such as for example diabetes, asthma or hypertension. Consequently, large numbers of patients are cared for with a largely standardized treatment plan over long periods of time (typically months or years), which leads to considerably increased cost efficiency in comparison with traditional patient care. However, there are limits to the extent to which the treatment plans can be standardized, since the individual situation of each patient has to be investigated, and differs on account of their age, the severity of the ailment, a possible intolerance to medicines or multimorbidity. Therefore, the standardized treatment plans must be individually adapted and possibly altered in the course of the period of care.

Until now, the treatment plans have been individually devised and monitored by the medically trained expert, which however, in view of the high costs, partly counteracts the aimed-for cost efficiency of disease management services as compared with traditional patient care.

U.S. Pat. No. 5,517,405 has already proposed an expert system for providing interactive assistance for the doctor when devising a treatment plan, but a question and answer procedure with varying degrees of guidance is used there as a basis for the expert system together act with the doctor to correct, improve and so on details of the treatment to be used as a proposal for a specific ailment. Automatic checking of a more complex treatment plan, especially also with regard to any intolerances, is not envisaged however, and nor is this possible, since the expert system does not have any access at all to the medical history of the patient, that is to say the records of said patient. However, the laborious interrogation of specific boundary conditions for taking into account such intolerances, for example, is at most guided by the expert system according to this U.S. Pat. No. 5,517,405, but in the final analysis is not speeded up and, in particular, a doctor is always required for each treatment plan and for checking it.

### SUMMARY OF THE INVENTION

The invention is therefore based on the object of providing a system which makes automated checking of treatment plans possible.

To achieve this object, such a system is characterized according to the invention by an expert system with implemented rules which, by accessing patient data in different patient records and/or with different doctors or clinics, independently subjects the treatment plan to a plausibility check, especially checks the treatment plan for contraindications with older patient data.

A treatment plan is understood in this context as meaning a machine-readable representation of a chronological sequence of working steps and decisions. The working steps are described by a general definition, for example “telemonitoring of blood pressure” or “medication with . . . ”, possibly supplemented by patient-specific information relevant for this working step, such as for example the age, weight, known drug intolerances or multimorbidity, etc. With this medical expert system, the consistency and freedom from contradictions of a treatment plan stored in a machine-readable form with further information sources is checked, such as for example databanks with medical guidelines and/or databanks with medical textbook knowledge (plausibility check).

Examples of such consistency checks are:

choice of the correct medication according to age or medical prehistory,

recommendations for physical activity (physio-therapeutic exercises, etc.) according to age, physical activeness, etc. of the patient,

checking for intolerance or side-effects in the case of second or multiple ailments (multimorbidity),

detection of knowledge of ineffective measures substantiated in guidelines on the symptoms to be treated, or

detection of the absence of measures which are recommended in guidelines.

If an inconsistency is detected, or a contradiction or possibly even a contraindication with older patient data, a warning message is output to the user.

In a development of the invention, it may be provided in this case that the system automatically carries out a cyclical repetition of the plausibility check with amended patient data or guidelines taken into account, it being possible for the cyclical repetition either to take place at predeterminable intervals or else to be initiated by new data inputs into the databanks used for the plausibility check.

The system according to the invention can in this case be integrated with particular advantage into a system for devising treatment plans, described in a parallel patent application, in which a databank is provided with a multiplicity of treatment modules stored in digital form, which can be interlinked with one another with the aid of operators to form a treatment plan, it being possible with preference to provide a graphic user interface to assist the selection and assembly of the predetermined treatment modules and also input devices for patient data for individualizing the treatment plan.

With these treatment plans, built up from clearly laid out macros or working modules, a machine-readable representation of a chronological sequence of working steps and decisions which are necessary and suitable for the purposes of the present invention for the checking procedure with the aid of an expert system is already obtained when the treatment plan is created.

### BRIEF DESCRIPTION OF THE DRAWINGS

Further advantages, features and details of the invention emerge from the following description of an exemplary embodiment and also on the basis of the drawing, which represents a schematic flow diagram of the system according to the invention for checking treatment plans.

### DETAILED DESCRIPTION OF THE INVENTION

From a databank 1 with treatment regimes and individual working modules for building up a linear or branched module chain, possibly with decision nodes and/or loops, an individual treatment regime 2, built up from standardized working modules, for a patient is built up with the aid of a graphic user interface (not shown), it being intended for the patient data in this individual treatment regime to include, for example, the statement that the patient is diabetic. The treatment plan, of which only a small detail is represented in the figure of course, includes, inter alia, a telemonitoring of blood pressure followed by a call to a call center, to carry out a control investigation if need be, with a decision node then either again instigating a telemonitoring of blood pressure at a later point in time 4, or else, if there is a different outcome of the control investigation, instigating for example a repeated control investigation at the time 4, which can be repeated several times if necessary.

In the given exemplary embodiment, it is intended that the patient is diabetic.

The expert system knows on the basis of the implemented rules that, in the case of a diabetic, a blood pressure measurement is in any event to be combined with a blood sugar measurement, since, without knowledge of the blood sugar, the blood pressure alone does not provide the necessary information for further decisions and assessments. In the given treatment plan, however, such a blood sugar investigation is absent, and the expert system, which if need be has access to further databanks relating to guidelines, textbook knowledge or an electronic patient file (EPR), can detect this possible contradiction or inconsistency of the treatment regime and report it to the user.

With the aid of the expert system 3, it is also possible here for contraindications to be registered.

1. A system for checking treatment plans, in the course of disease management services for patient information, instruction and motivation, possibly combined with telemonitoring of critical body values and, on this basis, early detection of risk situations, which comprises an expert system with expert rules stored in a computer databank which, by accessing patient data in different patient records and/or with different doctors or clinics, independently subjects the treatment plan to a plausibility check, especially checks the treatment plan for contraindications with older patient data.

2. The system as claimed in claim 1, wherein the treatment plan is built up in the form of a machine-readable representation of a sequence of working steps and decisions.

3. The system as claimed in claim 1, wherein said system is linked with databanks relating to medical guidelines, textbook knowledge, or EPR.

4. The system as claimed in claim 1, wherein said system automatically carries out a cyclical repetition, or repetition taking place in response to input of new patient data or medical guidelines, of the plausibility check with amended patient data or guidelines taken into account.

5. The system as claimed in claim 1, wherein said system is integrated into a system for devising treatment plans in which a multiplicity of treatment modules are stored in digital form in a databank and can be interlinked with one another with the aid of operators to form a treatment plan, with a graphic user interface to assist the selection and assembly of predetermined treatment modules preferably being provided.

6. The system as claimed in claim 2, wherein said system is linked with databanks relating to medical guidelines, textbook knowledge, or EPR.

7. The system as claimed in claim 2, wherein said system automatically carries out a cyclical repetition, or repetition taking place in response to input of new patient data or medical guidelines, of the plausibility check with amended patient data or guidelines taken into account.

8. The system as claimed in claim 3, wherein said system automatically carries out a cyclical repetition, or repetition taking place in response to input of new patient data or medical guidelines, of the plausibility check with amended patient data or guidelines taken into account.

9. The system as claimed in claim 6, wherein said system automatically carries out a cyclical repetition, or repetition taking place in response to input of new patient data or medical guidelines, of the plausibility check with amended patient data or guidelines taken into account.

10. The system as claimed in claim 2, wherein said system is integrated into a system for devising treatment plans in which a multiplicity of treatment modules are stored in digital form in a databank and can be interlinked with one another with the aid of operators to form a treatment plan, with a graphic user interface to assist the selection and assembly of predetermined treatment modules preferably being provided.

11. The system as claimed in claim 3, wherein said system is integrated into a system for devising treatment plans in which a multiplicity of treatment modules are stored in digital form in a databank and can be interlinked with one another with the aid of operators to form a treatment plan, with a graphic user interface to assist the selection and assembly of predetermined treatment modules preferably being provided.

12. The system as claimed in claim 4, wherein said system is integrated into a system for devising treatment plans in which a multiplicity of treatment modules are stored in digital form in a databank and can be interlinked with one another with the aid of operators to form a treatment plan, with a graphic user interface to assist the selection and assembly of predetermined treatment modules preferably being provided.

13. The system as claimed in claim 6, wherein said system is integrated into a system for devising treatment plans in which a multiplicity of treatment modules are stored in digital form in a databank and can be interlinked with one another with the aid of operators to form a treatment plan, with a graphic user interface to assist the selection and assembly of predetermined treatment modules preferably being provided.

14. The system as claimed in claim 8, wherein said system is integrated into a system for devising treatment plans in which a multiplicity of treatment modules are stored in digital form in a databank and can be interlinked with one another with the aid of operators to form a treatment plan, with a graphic user interface to assist the selection and assembly of predetermined treatment modules preferably being provided.

15. The system as claimed in claim 9, wherein said system is integrated into a system for devising treatment plans in which a multiplicity of treatment modules are stored in digital form in a databank and can be interlinked with one another with the aid of operators to form a treatment plan, with a graphic user interface to assist the selection and assembly of predetermined treatment modules preferably being provided.
